(19) United States
(12) Patent Application Publication
(10) Pub. No.: US 2006/0136919 A1
(43) Pub. Date: Jun. 22, 2006

(54) System and method for controlling thread suspension in a multithreaded processor

(75) Inventors: Kathirgamar Aingaran, Sunnyvale, CA (US); James P. Laudon, Madison, WI (US)

Correspondence Address: MARTINE PENILLA & GENCARELLA, LLP, 710 LAKEWAY DRIVE, SUITE 200, SUNNYVALE, CA, 94085, US

(73) Assignee: Sun Microsystems, Inc., Santa Clara, CA (US)

(21) Appl. No.: 11/095,840

(22) Filed: Mar. 30, 2005

Related U.S. Application Data
(63) Continuation-in-part of application No. 11/015,055, filed on Dec. 17, 2004.

(51) Int. Cl. G06F 9/46

(52) U.S. Cl. 718/100

(57) ABSTRACT

A multi-thread processor including a processing core. The processing core including multiple threads and a scheduler. The scheduler includes a thread state register. The thread state register being capable of storing a selective wait state for a selected one of the threads. A method of scheduling threads in a multi-thread processor is also disclosed.

### CROSS REFERENCE TO RELATED APPLICATIONS

This application is a continuation-in-part of and claims priority from U.S. patent application Ser. No. 11/015,055 filed on Dec. 17, 2004 and entitled “Method and Apparatus for Scheduling Multiple Threads for Execution in a Shared Microprocessor Pipeline,” which is incorporated herein by reference in its entirety.

### BACKGROUND OF THE INVENTION

1. Field of the Invention

The present invention relates generally to multithreaded processors, and more particularly, to systems and methods for selectively suspending processing of one or more selected threads in a multithreaded processor.

2. Description of the Related Art

Computer systems are constructed of many components, typically including one or more processors that are connected for access to one or more memory devices (such as RAM) and secondary storage devices (such as hard disks and optical discs). By way of example, FIG. 1 is a diagram illustrating a computer system 10 with multiple memories. Generally, a processor 1 connects to a system bus 12. Also connected to the system bus 12 is a memory (e.g., 14). During processor operation, CPU 2 processes instructions and performs calculations. Data for the CPU operation is stored in and retrieved from memory using a memory controller 8 and cache memory, which holds recently or frequently used data or instructions for expedited retrieval by the CPU 2. Specifically, a first level (L1) cache 4 connects to the CPU 2, followed by a second level (L2) cache 6 connected to the L1 cache 4. The CPU 2 transfers information to the L2 cache 6 via the L1 cache 4. Such computer systems may be used in a variety of applications, including as a server 10 that is connected in a distributed network, such as Internet or other network 9, enabling server 10 to communicate with clients A-X, 3, 5, 7.

Because processor clock frequency is increasing more quickly than memory speeds, there is an ever increasing gap between processor speed and memory access speed. In fact, memory speeds have only been doubling every six years, roughly one-third the rate of microprocessors. In many commercial computing applications, this speed gap results in a large percentage of time elapsing during pipeline stalling and idling, rather than in productive execution, due to cache misses and latency in accessing external caches or external memory following the cache misses. Stalling and idling are most detrimental, due to frequent cache misses, in database handling operations such as OLTP, DSS, data mining, financial forecasting, mechanical and electronic computer-aided design (MCAD/ECAD), web servers, data servers, and the like. Thus, although a processor may execute at high speed, much time is wasted while idly awaiting data.

One technique for reducing stalling and idling is hardware multithreading to achieve processor execution during otherwise idle cycles. FIGS. 2a and 2b show two timing diagrams illustrating an execution flow 22 in a single-thread processor and an execution flow 24 in a vertical multithread processor. Processing applications, such as database applications and network computing applications, spend a significant portion of execution time stalled awaiting memory servicing. This is illustrated in FIG. 2a, which depicts a highly schematic timing diagram showing execution flow 22 of a single-thread processor executing a database application. The areas within the execution flow 22 labeled as “C” correspond to periods of execution in which the single-thread processor core issues instructions. The areas within the execution flow 22 labeled as “M” correspond to time periods in which the single-thread processor core is stalled waiting for data or instructions from memory or an external cache. A typical single-thread processor executing a typical database application executes instructions about 25% of the time with the remaining 75% of the time elapsed in a stalled condition. The 25% utilization rate exemplifies the inefficient usage of resources by a single-thread processor.

FIG. 2b is a highly schematic timing diagram showing execution flow 24 of similar database operations by a multithread processor. Applications, such as database applications, have a large amount inherent parallelism due to the heavy throughput orientation of database applications and the common database functionality of processing several independent transactions at one time. The basic concept of exploiting multithread functionality involves using processor resources efficiently when a first thread is stalled by executing other threads while the stalled first thread remains stalled. The execution flow 24 depicts a first thread 25, a second thread 26, a third thread 27 and a fourth thread 28, all of which are labeled to show the execution (C) and stalled or memory (M) phases. As one thread stalls (e.g., first thread 25), another thread (such as second thread 26) switches into execution on the otherwise unused pipeline. There may also be times (not shown) when all threads are stalled. Overall processor utilization is significantly improved by multithreading. The illustrative technique of multithreading employs replication of registers for each thread and is called “vertical multithreading.”

Vertical multithreading is advantageous in processing applications in which frequent cache misses result in heavy clock penalties. When a cache miss causes a first thread to stall, vertical multithreading permits a second thread to execute when the processor would otherwise remain idle. The second thread thus takes over execution of the pipeline. A context switch from the first thread to the second thread involves saving the useful states of the first thread and assigning new states to the second thread. When the first thread restarts after stalling, the saved states are returned and the first thread proceeds in execution.

A thread can also stall because a next instruction to be executed in the thread requires a data value that is not yet available. The data not available is referred to as a contingency and the thread will remain stalled until the contingency is satisfied (i.e., until the needed data value becomes available). As a result, of the contingency not being satisfied, the processor core does two things. First, the processor core begins to execute an instruction on a next, non-stalled thread. Second, the processor core also periodically checks or polls to determine if the contingency has been satisfied. When the processor core detects that the contingency has been satisfied (i.e., the needed data value has become available), then the processor core can process the instructions in the previously stalled thread.

By way of example and with reference to FIG. 2b, if a processor is a 4-thread (threads 25-28) multithread processor and a first instruction in first thread 25 stalls (e.g., due to a contingency or a cache miss) then the processor core switches to a second instruction in second thread 26, executes the second instruction, then switches to the third thread 27 to execute a third instruction and then switches to a fourth instruction in fourth thread 28. Next, the processor core checks the first thread 25 to see if the contingency on the first instruction has been satisfied. If the contingency has not been satisfied, then the processor core switches to the second thread 26 to execute a fifth instruction and subsequently to instructions in the third and fourth threads 27 and 28 and so forth. The processor continues to check the first thread 25 to see if the contingency has been satisfied. This continual checking to see if the contingency has been satisfied wastes processor time while simultaneously and unnecessarily consuming power and producing heat.

Vertical multithreading also imposes costs on a processor in resources used for saving and restoring thread states, and may involve replication of some processor resources (e.g., replication of registers) for each of thread 25-28. In addition, vertical multithreading presents challenges for scheduling execution of the various threads 25-28 on a shared processor core or pipeline in a way that ensures correctness, fairness and maximum performance.

Unfortunately, no process or mechanism presently exists that allows software (e.g., an operating system or other application) or hardware (e.g., the processor) to selectively control which threads are being processed by the processor. In view of the foregoing, there is a need for a system and method for selectively controlling which threads are being processed by the processor. An improved method and system for scheduling thread execution on a shared processor can be more economical in resources and avoid costly overhead which reduces processor performance.

### SUMMARY OF THE INVENTION

Broadly speaking, the present invention fills these needs by providing a system and method for selectively controlling which threads are being processed by the processor core. It should be appreciated that the present invention can be implemented in numerous ways, including as a process, an apparatus, a system, computer readable media, or a device. Several inventive embodiments of the present invention are described below.

One embodiment provides a multi-thread processor including a processing core. The multi-thread processor including multiple threads and a scheduler. The scheduler includes a thread state register. The thread state register being capable of storing a selective wait state for a selected one of the threads. The selective wait state includes at least one of a group consisting of a halt state or an idle state.

Another embodiment provides a method of scheduling threads in a multi-thread processor. The method includes receiving a first instruction in a first thread of several threads in the multi-thread processor. The first instruction is a selective wait state instruction. The first instruction is executed including selecting one of the threads included in the multi-thread processor and setting a thread state to a selective wait state in a thread state register included in the multi-thread processor. The thread state register corresponds with the selected thread.

The selective wait state can include a halt state. The halt state can include holding multiple data values in the selected thread until a resume-halt instruction is received. The halt state can include not scheduling the selected thread for activity in the scheduler until a resume-halt instruction is received. The resume-halt includes receiving a second instruction to change the status of selected thread to an active state. The resume-halt includes at least one of an instruction, an interrupt or a reset. The second instruction is received in a second thread in the multi-thread processor that is not the selected thread.

The selective wait state can also include an idle state. The idle state includes holding multiple data values in the selected thread until a resume-idle instruction is received. The idle state includes not scheduling the selected thread for activity in the scheduler until a resume-idle instruction is received. The resume-idle includes receiving a second instruction to change the status of selected thread to an active state. The resume-idle includes at least one of an instruction or a reset.

The first instruction can be generated in response to at least one of a temperature of the multi-thread processor, a power consumption level of the multi-thread processor, or an error rate of the selected thread. Setting the thread state to a selective wait state in a thread state register can include selecting one of a halt state or an idle state.

Yet another embodiment provides a method of initializing a multi-thread processor. The method includes applying power to the multi-thread processor. The processor includes multiple threads. A selected at least one of the plurality of threads is placed in a selective wait state. Multiple operations are initialized in the multi-thread processor and the selected at least one of the threads is placed in an active state.

Placing the selected at least one of the threads in the selective wait state includes receiving a selective wait state instruction in a first thread of the multiple threads in the multi-thread processor and executing the first instruction. Executing the first instruction includes selecting one of the threads included in the multi-thread processor and setting a thread state to a selective wait state in a thread state register included in the multi-thread processor. The thread state register corresponds to the selected thread.

The selective wait state includes a halt state. Placing the selected at least one of the threads in an active state includes receiving a resume-halt instruction and executing the resume-halt instruction.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIG. 1 is a diagram illustrating a computer system with multiple memories.

FIG. 2a depicts a highly schematic timing diagram showing execution flow of a single-thread processor executing a database application.

FIG. 2b is a highly schematic timing diagram showing execution flow of similar database operations by a multithread processor.

FIG. 3 is a simplified schematic diagram of a processor chip 30 having multiple processor cores for processing multiple threads, in accordance with one embodiment of the present invention.

FIG. 4 is a timing diagram illustrating execution flow of a vertical multithreaded multiprocessor, in accordance with one embodiment of the present invention.

FIG. 5 is a block diagram or a processor core, in accordance with one embodiment of the present invention.

FIG. 6 is a diagram of the basic and speculative thread states in connection with an exemplary multithreaded processor system, in accordance with one embodiment of the present intention.

FIG. 7A is a state diagram for a selected thread, in accordance with one embodiment of the present invention.

FIG. 7B is a flowchart of the method operations for selectively controlling processing of a halted thread, in accordance with one embodiment of the present invention.

FIG. 7C is a flowchart of the method operations for selectively controlling processing of an idled thread, in accordance with one embodiment of the present invention.

FIG. 7D is a flowchart of the method operations for selectively controlling processing of a thread during start-up of a multi-threaded processor, in accordance with one embodiment of the present invention.

FIG. 8 is block diagram of an exemplary dataflow through a processor pipeline, in accordance with one embodiment of the present invention.

FIG. 9 is a flowchart diagram that illustrates the method operations performed for implementing an efficient and fair thread scheduling system and functionality, in accordance with one embodiment of the present invention.

### DETAILED DESCRIPTION OF THE EXEMPLARY EMBODIMENTS

Several exemplary embodiments for systems and methods for selectively controlling which threads are being processed by the processor core will now be described. It will be apparent to those skilled in the art that the present invention may be practiced without some or all of the specific details set forth herein.

As described above it can be desirable to selectively control which threads are being processed by the processor core. By way of example, if the multi-threaded processor is consuming too much power or is overheating, then the processing of one or more threads may be suspended to reduce power and/or reduce temperature of the processor.

It may also be desirable to selectively control which threads are being processed by the processor core so as to focus processing power on a single or limited number of threads. By way of example, during a processor start-up, it may be desirable to have only a single thread to perform the system initialization processes. Once the system is initialized, then the additional threads can be enabled to allow multi-threaded processing.

Yet another reason to selectively control which threads are being processed by the processor core is due to a hardware failure in a given thread. By way of example, if a first thread experiences errors due to a device failure, then it may be desirable for the operating system to detect the device failure and selective deactivate that thread.

Recall that stalling a thread in the multi-threaded processor, as described above, does not actually end all processing related to the stalled thread as the processor core must still check to see if the contingency that caused the stall has been satisfied. Therefore, if the goal of selectively controlling which threads are being processed by the processor core is to reduce power consumption and/or temperature of the processor or conserve processing resources, then the constant checking for the contingency to be satisfied is unnecessary processing that would needlessly consume additional power, generate heat, consume processing resources, etc.

The present invention provides a system and method for selectively controlling which threads are being processed by the processor core while eliminating the need to check for the contingency being satisfied.

### Multi-Thread Processors

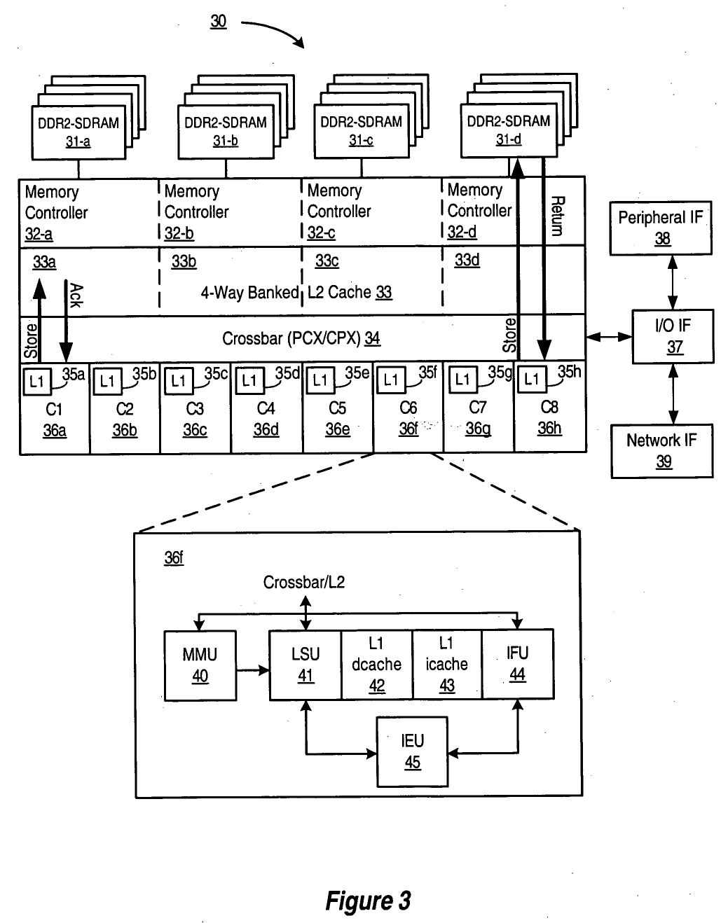

FIG. 3 is a simplified schematic diagram of a processor chip 30 having multiple processor cores for processing multiple threads, in accordance with one embodiment of the present invention. The multi-threaded processor 30 includes multiple processor cores 36a-h, which are also designated “C1” though “C8.” Each of cores 36 is coupled to an L2 cache 33 via a crossbar 34. L2 cache 33 is coupled to one or more memory controller(s) 32, which are coupled in turn to one or more banks of system memory 31. Additionally, crossbar 34 couples cores 36 to input/output (I/O) interface 37, which is in turn coupled to a peripheral interface 38 and a network interface 39.

Cores 36 can be configured to execute instructions and to process data according to a particular instruction set architecture (ISA). The cores 36 can be configured to implement the SPARC V9 ISA, although in other embodiments, it is contemplated that any desired ISA can be employed (e.g., x86, PowerPC or MIPS). In a selected embodiment, a highly suitable example of a processor design for the processor core is a SPARC processor core, UltraSPARC processor core or other processor core based on the SPARC V9 architecture. Those of ordinary skill in the art also understand the present invention is not limited to any particular manufacturer's microprocessor design. The processor core may be found in many forms including the 64-bit SPARC RISC microprocessor from Sun Microsystems, or any 32-bit or 64-bit microprocessor manufactured by Motorola, Intel, AMD or IBM. However, any other suitable single or multiple microprocessors, microcontrollers or microcomputers may be utilized. In the illustrated embodiment, each of cores 36 can be configured to operate independently of the others, such that all cores 36 can execute in parallel.

Each of cores 36 can be configured to execute multiple threads concurrently, where a given thread can include a set of instructions that can execute independently of instructions from another thread. By way of example, an individual software process or an application can include one or more threads that can be scheduled for execution by an operating system. Such a core can also be referred to as a multithreaded (MT) core. In the example shown in FIG. 3, each processor core includes four threads. Thus, a single processor chip 30 with eight cores (C1 through C8) will have thirty-two threads in this configuration. However, it should be appreciated that the invention is not limited to eight processor cores, and that more or fewer cores can be included. In other embodiments, it is contemplated that each core can process different numbers of threads (e.g., eight threads per core). As will be described in more detail below, one or more embodiments of the present invention can be enabled on a single core processor having a single thread or more than one thread. Similarly, one or more embodiments of the present invention can be enabled on a multiple core processor where each of the multiple cores has one or more threads. By way of example, a single processor chip 30 with eight cores (C1 through C8) will have eight or more threads in this configuration.

The example core 36f includes an instruction fetch and scheduling unit (IFU) 44 that is coupled to a memory management unit (MMU) 40, the load store unit (LSU) 41 and at least one instruction execution unit (IEU) 45. Each execution unit 45 is also coupled to the LSU 41, which is coupled to send data back to each execution unit 45. Additionally, the LSU 41, IFU 44 and MMU 40 are coupled (through an interface) to the crossbar 34.

Each processor core 36a-36h is in communication with crossbar 34 that manages data flow between cores 36 and the shared L2 cache 33, and that can be optimized for processor traffic where it is desirable to obtain extremely low latency. The crossbar 34 can be configured to concurrently accommodate a large number of independent accesses that are processed on each clock cycle, and enables communication data requests from cores 36 to L2 cache 33, as well as data responses from L2 cache 33 to cores 36.

The crossbar 34 can include logic (e.g., multiplexers or a switch fabric, etc.) that allows any core 36 to access any bank of L2 cache 33, and that conversely allows data to be returned from any L2 bank to any core. Crossbar 34 can also include logic to queue data requests and/or responses, such that requests and responses may not block other activity while waiting for service. Additionally, the crossbar 34 can be configured to arbitrate conflicts that may occur when multiple cores attempt to access a single bank of L2 cache 33 or vice versa. Thus, the multiple processor cores 36a-36h share a second level (L2) cache 33 through the crossbar 34.

The shared L2 cache 33 accepts requests from the processor cores 36 on the processor to cache crossbar (PCX) 34 and responds on the cache to processor crossbar (CPX) 34. The L2 cache 33 includes four banks that are shared by the processor cores. It should be appreciated that, by sharing L2 cache banks, concurrent access may be made to the multiple banks, thereby defining a high bandwidth memory system. The invention is not limited to four L2 cache banks or to any particular size, but the illustrated embodiment should be sufficient to provide enough bandwidth from the L2 cache to keep all of the cores busy most of the time.

As illustrated, L2 cache 33 can be organized into four or eight separately addressable banks that may each be independently accessed, such that in the absence of conflicts, each bank can concurrently return data to any of the processor cores 36a-h. Each individual bank can also be implemented using set-associative or direct-mapped techniques. By way of example, the L2 cache 33 can be a four-way banked 3 megabyte (MB) cache, where each bank (e.g., 33a) is set associative, and data is interleaved across banks, although other cache sizes and geometries are possible and contemplated.

In connection with the example described herein, each processor core (e.g., 36f) shares an L2 cache memory 33 to speed memory access and to overcome the delays imposed by accessing remote memory subsystems (e.g., 31). Cache memory can include one or more levels of dedicated high-speed memory holding recently accessed data, designed to speed up subsequent access to the same data. When data is read from main memory (e.g., 31), a copy is also saved in the L2 cache 33, and an L2 tag array stores an index to the associated main memory. The L2 cache 33 then monitors subsequent requests for data to see if the information needed has already been stored in the L2 cache. If the data had indeed been stored in the cache (i.e., a “hit”), the data is delivered immediately to the processor core 36 and the attempt to fetch the information from main memory 31 is aborted (or not started). If, on the other hand, the data had not been previously stored in L2 cache (i.e., a “miss”), the data is fetched from main memory 31 and a copy of the data and its address is stored in the L2 cache 33 for future access.

The L2 cache 33 is in communication with main memory controller 32 to provide access to the external memory 31 or main memory (not shown). Memory controller 32 can be configured to manage the transfer of data between L2 cache 33 and system memory (e.g., in response to L2 fill requests and data evictions). Multiple instances of memory controller 32 can be implemented, with each instance configured to control a respective bank of system memory. Memory controller 32 can be configured to interface to any suitable type of system memory, such as Double Data Rate or Double Data Rate 2 Synchronous Dynamic Random Access Memory (DDR/DDR2 SDRAM), or Rambus DRAM (RDRAM). The memory controller 32 can be configured to support interfacing to multiple different types of system memory.

As illustrated, processor chip 30 can be configured to receive data from sources other than system memory 31. I/O interface 37 can be configured to provide a central interface for such sources to exchange data with cores 36 and/or L2 cache 33 via crossbar 34. The I/O interface 37 can be configured to coordinate Direct Memory Access (DMA) transfers of data between network interface 39 or peripheral interface 38 and system memory 31 via memory controller 32. In addition to coordinating access between crossbar 34 and other interface logic, the I/O interface 37 can be configured to couple processor chip 30 to external boot and/or service devices.

The peripheral interface 38 can be configured to coordinate data transfer between processor chip 30 and one or more peripheral devices. Such peripheral devices can include, without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. The peripheral interface 38 can also implement one or more instances of an interface such as Peripheral Component Interface Express (PCI-Express), although it is contemplated that any suitable interface standard or combination of standards may be employed. By way of example, the peripheral interface 38 can be configured to implement a version of Universal Serial Bus (USB) protocol or IEEE 1394 (Firewire) protocol in addition to or instead of PCI-Express.

The network interface 39 can be configured to coordinate data transfer between processor chip 30 and one or more devices (e.g., other computer systems) coupled to processor chip 30 via a network. The network interface 39 can be configured to perform the data processing necessary to implement an Ethernet (IEEE 802.3) networking standard (e.g., Gigabit Ethernet or 10-gigabit Ethernet), although it is contemplated that any suitable networking standard can be implemented. In some embodiments, network interface 39 can be configured to implement multiple discrete network interface ports.

The multiprocessor chip 30 described herein and exemplified in FIG. 3 can be configured for multithreaded execution. More specifically, each of the cores 36 can be configured to perform fine-grained multithreading, in which each core may select instructions to execute from among a pool of instructions corresponding to multiple threads, such that instructions from different threads may be scheduled to execute adjacently. By way of example, in a pipelined embodiment of core 36f employing fine-grained multithreading, instructions from different threads may occupy adjacent pipeline stages, such that instructions from several threads may be in various stages of execution during a given core processing cycle.

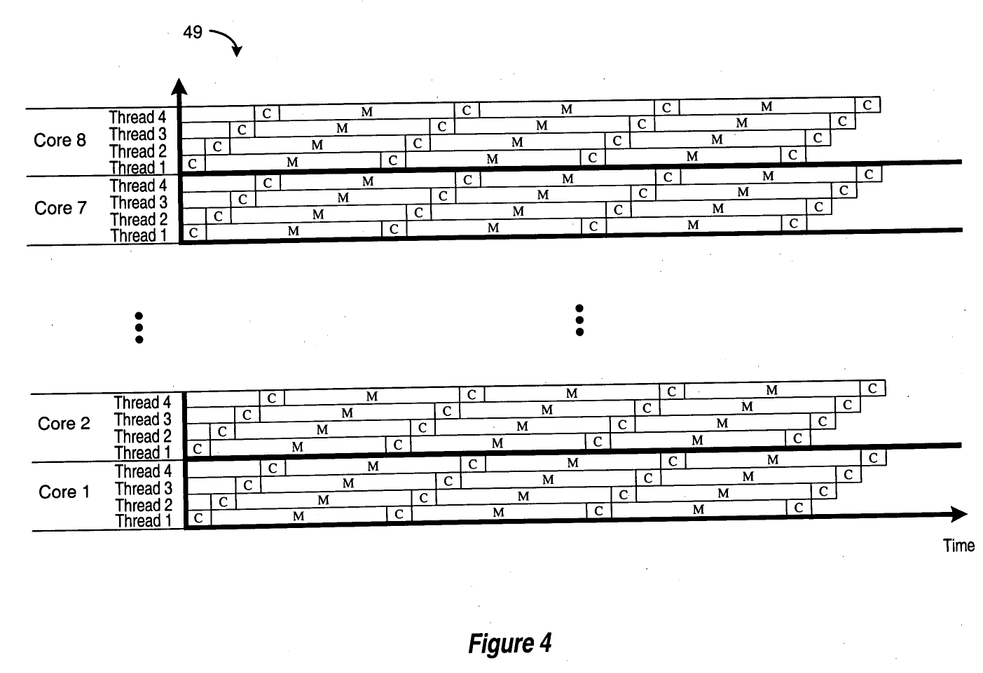

FIG. 4 is a timing diagram 49 illustrating execution flow of a vertical multithreaded multiprocessor, in accordance with one embodiment of the present invention. The vertical multithreaded multiprocessor has a high throughput architecture with eight processor cores (Core 1-Core 8), each having four threads. While the present invention may be implemented on a vertical multithreaded processor where a memory space (e.g., L2 cache) is shared by the threads, the invention may also be implemented as a horizontal multithreaded processor where the memory space is not shared by the threads, or with some combination of vertical and horizontal multithreading. The present invention can also be enabled on non-multi thread processors (e.g., a processor having one or more cores and each core has one corresponding thread). By way of example, a single processor chip 30 with eight cores (C1 through C8) can have eight threads (i.e., one thread corresponding to each of cores C1 through C8).

Referring now to FIG. 4, the execution flow for a given vertical threaded processor (e.g., Core 1) includes execution of multiple threads (e.g., Threads 1-4). For each thread in each core, the areas labeled “C” show periods of execution and the areas labeled “M” show time periods in which a memory access is underway, which would otherwise idle or stall the processor core. Thus, in the first processor core (Core 1), Thread 1 uses the processor core (during the times labeled as “C”) and then is active in memory (during the times labeled as “M”). While Thread 1 in a given core is active in memory, Thread 2 in that same core accesses the processor core and so on for Thread 3 and Thread 4. Vertical multithread processing is implemented by maintaining a separate processing state for each executing thread on a processing core. With only one of the threads being active at one time, each vertical multithreaded processor core switches execution to another thread during a memory access, such as on a cache miss. In this way, efficient instruction execution proceeds as one thread stalls and, in response to the stall, another thread switches into execution on the otherwise unused pipeline.

The processor cores can be replicated any number of times in the same area. This is also illustrated in FIG. 4, which illustrates the timing diagram 49 for an execution flow of a vertically threaded processor using a technique called chip multiprocessing. This technique combines multiple processor cores on a single integrated circuit die. By using multiple vertically threaded processors, each of which (e.g., Core 1) is vertically threaded, a processor system is formed with augmented execution efficiency and decreased latency in a multiplicative fashion. The execution flow 49 illustrated in FIG. 4 for a vertical threaded processor includes execution of threads 1-4 on a first processor core (Core 1), execution of threads 1-4 on a second processor core (Core 2), and so on with processor cores 3-4. Execution of threads 1-4 on the first processor core (Core 1) illustrates vertical threading. Similarly, execution of threads 1-4 on the second processor (Core 2) illustrates vertical threading.

Where a single system or integrated circuit includes more than one processor core, the multiple processor cores executing multiple threads in parallel is a chip multithreading (CMT) processor system. The combination of multiple cores with vertical multithreading increases processor parallelism and performance, and attains an execution efficiency that exceeds the efficiency of a single core with vertical multithreading. The combination of multiple vertically threaded cores also advantageously reduces communication latency among local (on-chip) multi-processor tasks by eliminating much signaling on high-latency communication lines between integrated circuit chips. Multicore multithreading further advantageously exploits processor speed and power improvements that inherently result from reduced circuit sizes in the evolution of silicon processing.

With the use of multiple vertically threaded processors, each processor core pipeline overlaps the execution of multiple threads to maximize processor core pipeline utilization. As will be appreciated, the multiplicity of thread operations from a vertically threaded processor (e.g., Core 1) will require a sequencing of the thread executions that is both fair and efficient. By way of example, a thread that has become unavailable due to a long latency operation can have its execution unduly delayed if priority is granted on the basis of current readiness. Examples of long latency operations include load, branch, multiply or divide operations. In addition, a thread can become unavailable due to a pipeline stall, such as a cache miss, a trap or other resource conflicts.

### Thread Scheduling

The present invention may be applied in a variety of applications to schedule thread execution in a multithreaded, high throughput processor core in a way that ensures no deadlocks or livelocks, while maximizing aggregate performance and ensuring fairness between threads. While the thread selection functionality can be implemented anywhere in the front-end of the processor pipeline.

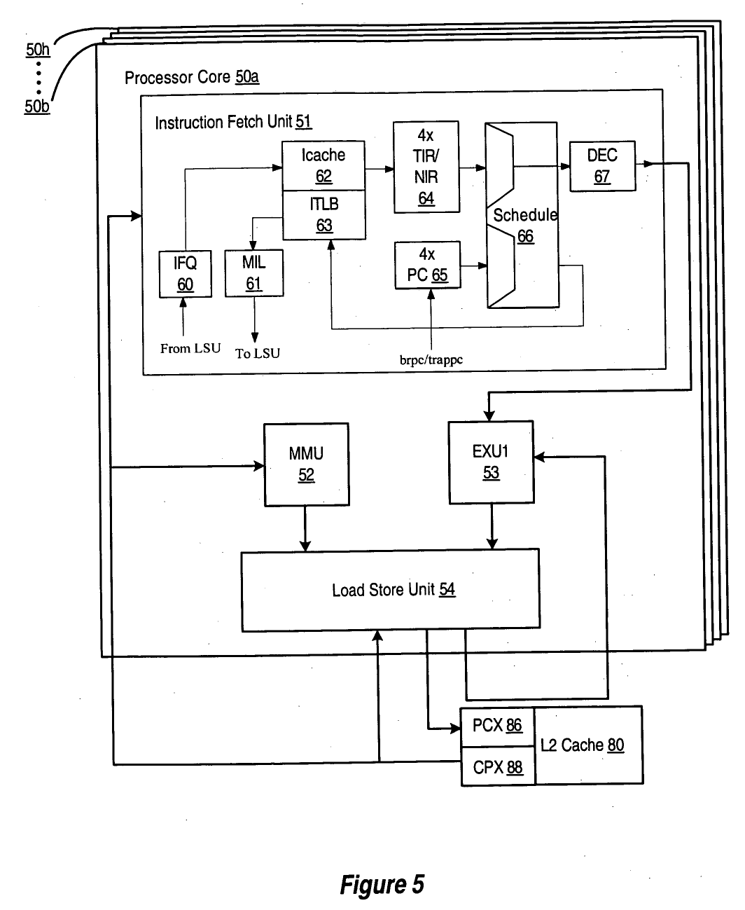

FIG. 5 is a block diagram or a processor core 50a, in accordance with one embodiment of the present invention. The processor core 50a implements thread scheduling in the instruction fetch unit (IFU) 51. In particular, the processor core 50a includes an IFU 51 that is coupled to a memory management unit (MMU) 52 and at least one instruction execution unit (EXU1) 53. The instruction fetch unit 51 can include logic configured to translate virtual data addresses (VA) to physical addresses (PA), such as an Instruction Translation Lookaside Buffer (ITLB) 63. Each execution unit 53 is coupled to a load store unit (LSU) 54. Additionally, LSU 54, IFU 51 and MMU 54 are coupled directly or indirectly to the L2 cache 80 via crossbar 86, 88.

In operation, the instruction fetch unit (IFU) 51 retrieves two instructions for each thread from the instruction cache 62 and writes the instructions into two instruction registers (TIR/NIR 64): a thread instruction register (TIR) for holding the current stage instruction, and a next instruction register (NIR) for holding the instruction at the next PC.

If the next required instruction is not stored in the instruction cache 62, the IFU 51 fetches the instruction from the instruction fill queue (IFQ) 60 which buffers instructions obtained from the LSU 54. The memory location of the next instruction to be retrieved for each thread is specified in the program counter (PC) register 65. By way of example, the program counter can be simply incremented to identify the next memory address location or can be specified by the branch program counter (brpc) or trap program counter (trappc) signals provided to the PC register 65.

When the location for the next instruction is in the instruction cache 62, the Instruction Translation Lookaside Buffer (ITLB) 63 can be used to specify the instruction cache memory address for the next instructions. Thus, the current instruction is stored in the instruction registers (TIR/NIR 64), and the associated program counter is stored in a PC register 65. The scheduling unit 66 selects a thread to execute from among the different threads, retrieves the selected thread's instruction and program counter from the TIR and PC registers 64, 65, and provides the selected thread's instruction and program counter to the decode unit 67 which decodes the instruction and supplies the pre-decoded instruction to the execution unit 53.

As will be appreciated, after an instruction retrieved from the TIR is scheduled, the instruction in the NIR is moved to the TIR; however, during fill operations, the instruction cache can be bypassed and the instruction is written to the TIR, but not the NIR.

Each execution unit 53 includes an arithmetic logic unit (ALU) for performing multiplication, shifting and/or division operations. In addition, the execution unit 53 processes and stores thread status information in integer register files. Execution unit results are supplied to the LSU 54 that handles memory references between the processor core, the L1 data cache and the L2 cache. The LSU 54 also receives a listing of any instructions that miss in the instruction cache 62 from the miss instruction list buffer 61.

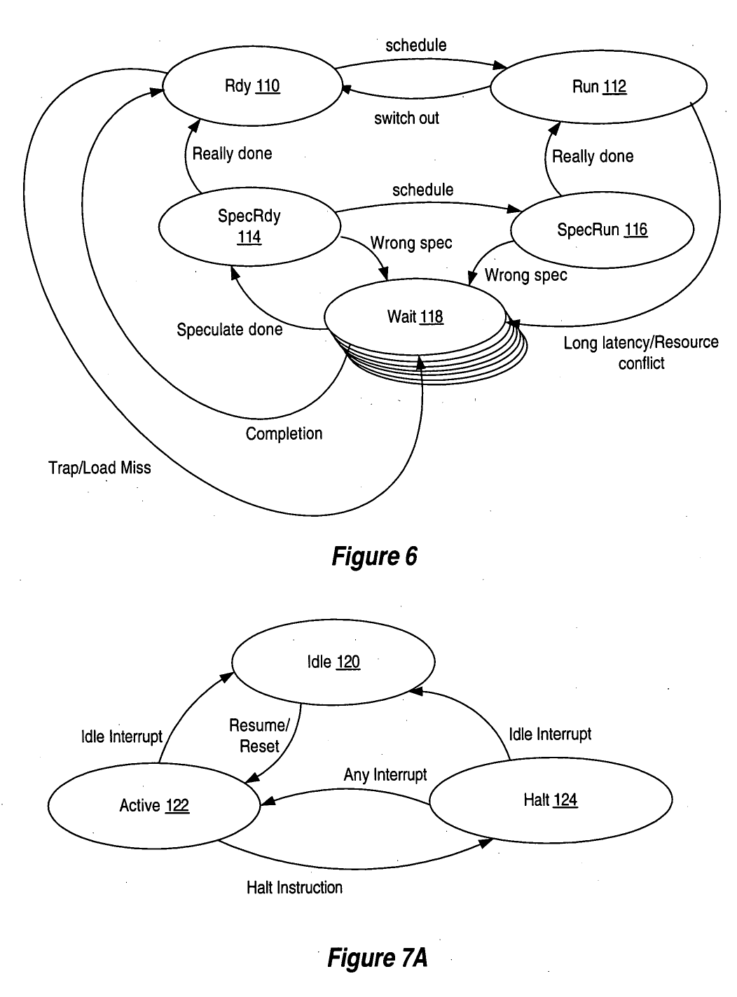

FIG. 6 is a diagram of the basic and speculative thread states in connection with an exemplary multithreaded processor system, in accordance with one embodiment of the present intention. Each thread can be in any one of eleven different active states, including a ready (Rdy) state 110, a run (Run) state 112, a speculative ready (SpecRdy) state 114, a speculative run (SpecRun) state 116 and any one of seven different wait (Wait) states 118.

The wait states 118 can include an instruction fill wait state (waiting for an Ifill operation), a store buffer full wait state (waiting for room in a store buffer), a long latency or resource conflict wait state (waiting for a long latency operation, where all resource conflicts arise as a result of a long latency), or any combination of the foregoing wait states. The wait states 118 can include selective wait states including a halt state and an idle state as will be described in more detail below. Selective wait states can be selectively implemented by hardware and software to cause a selected thread to be placed in a wait state. The selectively wait stated thread can also be selectively resumed.

The status for a particular thread can be tracked as it moves from one state to another. By way of example, an instruction (e.g., a load instruction) for a thread that is in a ready state 110 transitions to a run state 112 when it is scheduled for execution, but can be transitioned to a wait state 118 if there is long latency or other resource conflict that prevents execution of the instruction, or can transition back to the ready state 110 if the thread is switched out of order. Once in the wait state 118, the thread status returns to the ready state 110 when conditions causing a thread to be stalled clear (e.g., the requested data is ready for loading). Alternatively, a thread in the ready state 110 can transition to the wait state 118 if there is a software trap or load miss from the cache.

The speculative states can also be tracked and scheduled by introducing speculative states 114, 116 whereby a thread can be speculatively scheduled for execution, thereby improving usage of the execution pipe. By way of example, a thread in the wait state 118 transitions to the speculative ready state 114 by speculating when the condition stalling the thread will be cleared (e.g., assuming an L1 cache hit with a known arrival time), and transitions further to the speculative run state 116 by speculating when the thread would be scheduled for execution. As another example, a load instruction is speculated as a cache hit and the thread is switched in with a lower priority. If the speculation was wrong, the thread state returns to the wait state 118, but if the speculation was right and the stall condition cleared as predicted (e.g., the data or instruction was actually in the L1 cache), the thread transitions to the ready state 100 and run state 112 for execution.

### Selective Wait States

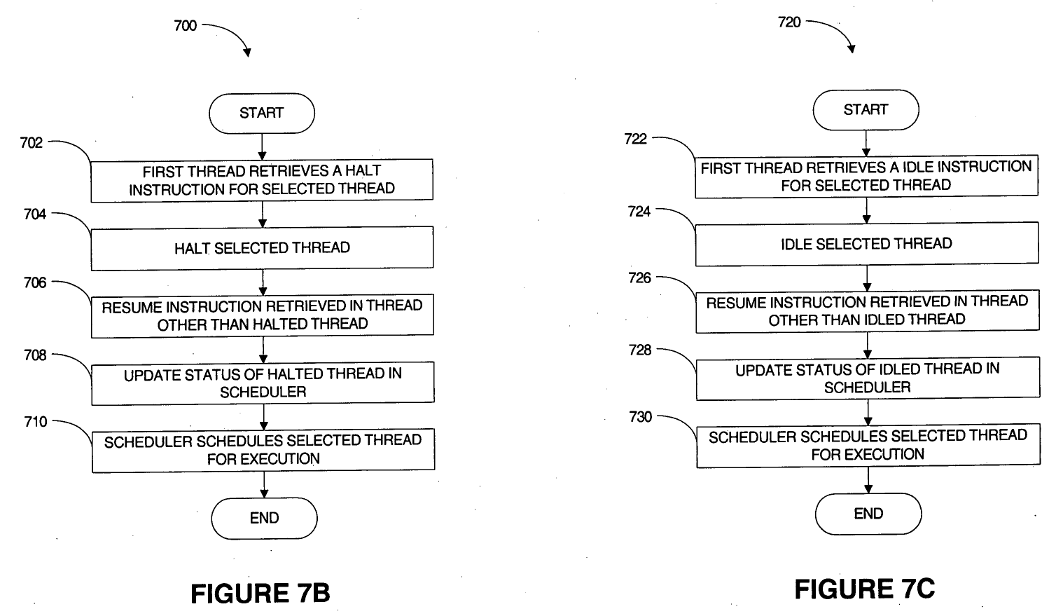

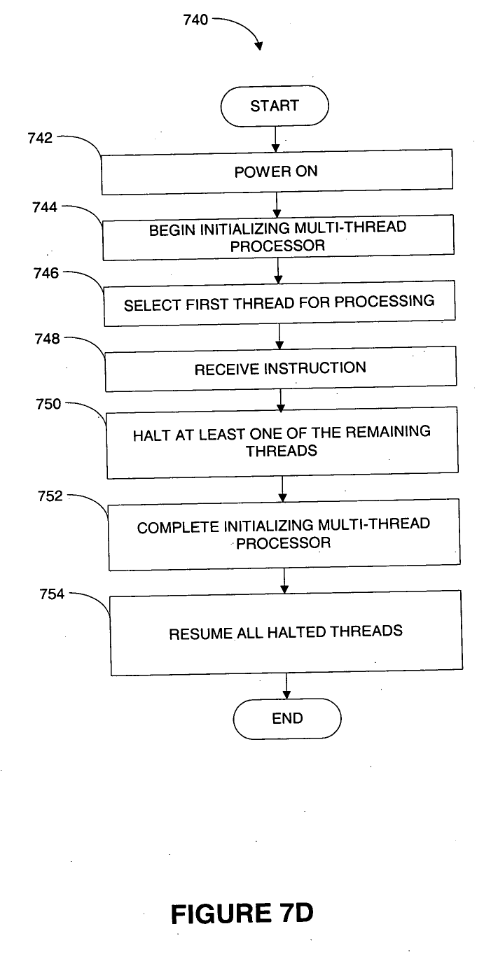

Selective wait states including the halt state and the idle state enable a selected thread to be selectively set to a wait state. This may be desirable due to a power consumption, heat control or operational simplification of the multi-thread processor or as a response to excess errors in the selected thread. FIG. 7A is a state diagram for a selected thread, in accordance with one embodiment of the present invention. In addition to the active thread states 122 described above, FIG. 7A shows that each thread can also be in a selective wait state including an idle state 120 oi a halt state 124. In the idled state 120, the thread is effectively dead to the world and a specific resume instruction or hardware reset is required to return to the active state 122. The idle state 120 is not normally used in programming applications. An operating system might determine that an excess error rate is occurring in the selected thread and then selectively place the selected in the idle state 120. By way of example, the selected thread may be experiencing excess errors due to device failures within the devices that make-up or support the thread or due to excess heat in those devices. Alternatively, the idle state 120 can be used to control the power consumption of a processor core (e.g., if excessive heat is detected at the core).

In comparison, the halt state 124 can be used to selectively temporarily stop a thread until an external interrupt is received. Programming applications including power save applications can use the halt state 124 or other applications where a specific response is expected. By way of example, with web server programs where a form is sent out to a user to be filled out and returned, the halt state 124 can be used to suspend the thread until the form return generates an interrupt for the thread.

Two selective wait states (e.g., the halt state 124 and the idle state 122) provide a first selective wait state (e.g., halt state 124), where the thread can be temporarily stopped from executing, but the thread can be easily awakened to service an unexpected event such as an external interrupt. In a second selective wait state (e.g., idle state 122), software can stop the thread from executing under any circumstances, until a resume message is received. The idle state 122 is a more drastic operation, that may be useful if there was something wrong with the thread or if the processor temperature his risen to intolerable levels or some other initiating factor.

As illustrated, an active thread transitions to the idle state 120 when an idle interrupt or instruction for the active thread is processed. The idle state 120 thread only returns to the active state 122 when a resume or reset interrupt is processed.

Alternatively, an active thread transitions to the halt state 124 when a halt instruction for the thread is processed. Once in a halt state 124, the thread can transition to the idle state when an idle interrupt for the thread is processed, or can return to the active state 122 when any other interrupt is processed.

A thread can place itself in the halted state by receiving a “halt” message or executing a halt instruction. The halt instruction can be a synthetic instruction that maps to a register with a data value. By way of example, the halt instruction can map to a register that has bit 0 clear to indicate a halt state 120. A halted thread does not execute any instructions after the halt instruction has been executed. While in the halted state, the halted thread can respond to an interrupt, a resume instruction, and a reset to resume the thread. The halted thread does not save or transfer the contents of the thread's architectural state (e.g. register files). Instead, the values are frozen right in place until the thread is resumed. In this way the halted thread can resume right where the thread left off.

Receipt of an interrupt will take the thread to the active state, where if interrupt is enabled it will take the interrupt. Setting an interrupt flag to a corresponding enabled value (e.g., 1=enabled) can enable the interrupt. Once the interrupt is serviced the thread will resume execution of the instruction following the halt (i.e. the thread remains active). If interrupt is disabled, the interrupt will remain pending and the thread will resume execution with the instruction following the halt. Setting an interrupt flag to a corresponding disabled value (e.g., 0=disabled) can disable the interrupt. If the halted thread is sent a resume, the thread will resume execution with the instruction following the halt. Finally, if the halted thread is sent a reset, the thread will take a reset trap of the appropriate reset type.

A thread may be placed in the idle state by receiving an idle message or instruction. The idle message can be generated via a register. An idle thread does not execute any instructions beyond where it received the idle message. While in the idle state, the thread will respond to a resume or a reset. Interrupts have no effect on an idle thread. If the idle thread is sent a resume instruction, the idle thread will resume execution where it left off. If the idle thread is sent a reset, the idle thread will take a reset trap of the appropriate reset type.

FIG. 7B is a flowchart of the method operations 700 for selectively controlling processing of a halted thread, in accordance with one embodiment of the present invention. In an operation 702, a first thread retrieves a first instruction. The first instruction can be a halt instruction for a selected thread. The selected thread can be the first thread or one of the other threads presently being scheduled for execution by the scheduler 216. By way of example, the first thread can retrieve the first instruction and the first instruction can cause the first thread to be halted. Alternatively, the first thread can retrieve the first instruction and the first instruction can cause a second thread to be halted.

In an operation 704, the selected thread is halted (i.e., placed in a halt state 124). One manner in which the selected thread can be halted is to set the selected threads status in the thread state register 218 to a halt state 124. While the selected thread has the status of halted in the scheduler 216, the selected thread is given the lowest priority and is not scheduled for execution. Further, as the status for the selected thread is halted, the scheduler does not check to see if the reason for the halted status has been cleared. By way of example and as described above, typically when a selected thread has a wait status, then the scheduler 216 is constantly checking to see if the cause of the wait status has been resolved. In contrast, when the selected thread has a status of halted, the scheduler 216 does not check to see if the cause of the halted status 124 has been resolved. The scheduler 216 scheduler performs no processing on the halted thread until a resume instruction is executed.

In an operation 706, a resume-halt instruction can be received in any thread other than the currently halted thread. In an operation 708, the resume-halt instruction is executed. By way of example, if the first thread retrieved the first instruction and the first instruction caused the second thread to be halted, then the first thread can retrieve the resume-halt instruction instructing the status of the second thread to be updated to any one of the active states 122 (e.g., ready state 110, the run state 112, a speculative ready state 114, a speculative run state 116 and any one of other different wait (Wait) states 118) other than a halt 124 or an idle state 120. The resume-halt instruction can also include an interrupt such as a hardware or software interrupt. In an operation 710, the scheduler 216 schedules the resumed thread for execution. The resume-halt instruction can alternatively include an idle instruction as will be described in FIG. 7C as follows.

FIG. 7C is a flowchart of the method operations 720 for selectively controlling processing of an idled thread, in accordance with one embodiment of the present invention. The method operations 720 for selectively controlling processing of an idled thread is substantially similar to the method operations 700 for selectively controlling processing of a halted thread shown in FIG. 7B above, except that the resume instruction operation is more restrictive.

In an operation 722, a first thread retrieves a first instruction. The first instruction can be an idle instruction for a selected thread. The selected thread can be the first thread or one of the other threads presently being scheduled for execution by the scheduler 216. By way of example, the first thread can retrieve the first instruction and the first instruction can cause the first thread to be idled. Alternatively, the first thread can retrieve the first instruction and the first instruction can cause a second thread to be idled.

In an operation 724, the selected thread is idled (i.e., placed in an idle state 120). One manner is which the selected thread can be idled is to set the selected threads status to an idle state 120. While the selected thread has the status of idled in the scheduler 216, the selected thread is given the lowest priority and is not scheduled for execution. Further, as the status for the selected thread is idled, the scheduler does not even check to see if the reason for the idled status has been cleared. By way of example and as described above, typically when a selected thread has a wait status, then the scheduler 216 is constantly checking to see if the cause of the wait status has been resolved. In contrast, when the selected thread has a status of idled, the scheduler 216 does not check to see if the cause of the idle status 120 has been resolved.

In an operation 726, a resume-idle instruction can be received in any thread other than the currently idled thread or a halted thread. In an operation 728, the resume-idle instruction is executed. By way of example, if the first thread retrieved the first instruction and the first instruction caused the second thread to be idled, then the first thread can retrieve the resume-idle instruction instructing the status of the second thread to be updated to any one of the active states 122 (e.g., ready state 110, the run state 112, a speculative ready state 114, a speculative run state 116) or any one of other different wait (Wait) states 118 other than a halt 124 or an idle state 120. The resume-idle instruction can also include a hardware interrupt such as reboot or restart interrupt. In an operation 730, the scheduler 216 schedules the resumed thread for execution.

When the thread shifts from active state 120 to halt state 124, the thread may actually execute a few instructions that follow the halt instruction which put it in the halt state 124. If an interrupt is pending and the halt instruction is issued, the thread will transition to the halted state and then back to the active state, effectively making the halt instruction a non-op when interrupts are pending.

Placing a thread in the idle or halted state has no effect on cache coherence. Caches will continue to maintain coherence even if all threads that access that cache are placed in the idle or halted states. Error logging will continue to take place even while a thread is in the idle or halted state.

If a thread desires to send an interrupt to itself to take it out of the halted state, a race exists where the interrupt could be received before the halt instruction completes. To avoid this race, the following sequence can be used:

disable interrupt

set up interrupt

halt

enable interrupt

Having interrupts disabled while setting up the interrupt guarantees that the interrupt will not be taken before the halt instruction. The halted state is exited when the interrupt is received, even though interrupt is disabled. Enabling the interrupt will result in the interrupt being taken.

The halt instruction can be used as an interrupt barrier. If, while expecting an interrupt, the interrupt is enabled and a halt instruction is executed, the interrupt will be taken before any instructions following the halt are executed.

FIG. 7D is a flowchart of the method operations 740 for selectively controlling processing of a thread during start-up of a multi-threaded processor, in accordance with one embodiment of the present invention. In an operation 742, power is applied to the microprocessor and in an operation 744 the processor begins initializing. The initialization of the processor is very important and all of the actual data processing must wait until the processor is fully initialized. For this reason, the multi-thread capability of the processor is not as important and the power savings provided by not using some of the multiple threads can be very important. By way of example, if the multi-thread processor is in a portable computer system, then power savings can be very important to limit the drain on the portable power supply (e.g., battery). Further, there is little gain in processing the initialization through multiple threads, as the initialization process is typically not as processing power intensive as the data processing the multi-thread processor is designed to perform.

In an operation 746 a first thread is selected for processing. The scheduler 216 selects the first thread. The initialization process includes an instruction or instructions that select and halt one or more threads that are that are not used for the initialization process.

In an operation 748, the instruction or instructions that select and halt one or more threads that are that are not used for the initialization process are received in the first thread. In an operation 750, the instruction is executed and at least one of the multiple threads are selected and halted as described above in FIG. 7B.

In an operation 752, the processor completes initialization. In an operation 754 the threads halted in operation 750 above are resumed as described above in FIG. 7B.

### Pipeline Dataflow

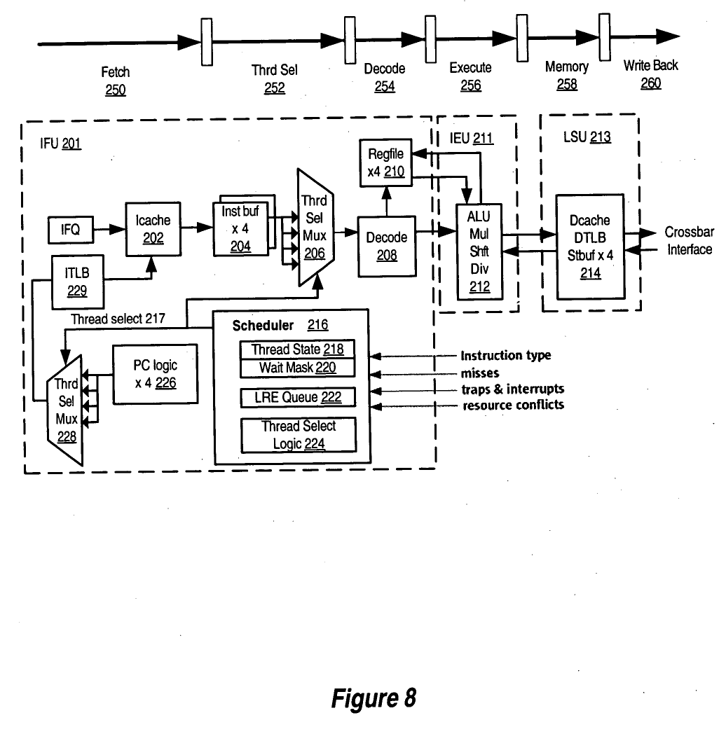

FIG. 8 is block diagram of an exemplary dataflow through a processor pipeline, in accordance with one embodiment of the present invention. The thread scheduler 216 prioritizes threads for processing in the pipeline based on the current thread status. While other pipeline structures can be used, FIG. 8 depicts the six-stage pipeline diagram showing the flow of integer instructions through one embodiment of a core (e.g., 50a). Multiple threads are pipelined so that processing of new instructions can begin before older instructions have completed. As a result, multiple instructions from various threads can be in various stages of processing during a given core execution cycle. As illustrated, the execution of integer instructions is divided into six stages, denoted as a Fetch (F) stage 250, a Schedule stage (S) 252, a Decode (D) stage 254, an Execute (E) stage 256, a Memory (M) stage 258 and a Writeback (WB) stage 260. It is contemplated that different numbers of pipeline stages corresponding to different types of functionality can be employed. It is further contemplated that other pipelines of different structure and depth can be implemented for integer or other instructions.

The first three stages (F-S-D) 250-254 of the illustrated integer pipeline can generally correspond to the functioning of instruction fetch unit 201, and function to deliver instructions to the execution unit 211. The final three stages (E-M-WB) 256-260 of the integer pipeline can generally correspond to the functioning of the execution unit 211 and LSU 213.

On a predetermined basis (such as at each cycle), the current status of each thread is recorded by the scheduler 216, which receives, for each thread, information concerning instruction type, any cache misses, traps and interrupts and resource conflicts. This information is stored or tracked in a thread state register 218 in the pipeline front-end, while the current wait state for each thread is tracked or stored in a wait mask or status register 220 in the pipeline front-end. The thread state register 218 can track a run state, a ready state, a speculative run state, and a speculative ready state for each thread. In addition, a busy register (not shown) can keep track of usage of long latency shared resources. Threads which are waiting for the availability of a shared resource are waitlisted in the wait mask register 220 for each resource to ensure there are no deadlocks or livelocks between threads vying for access to shared resources. To this end, the wait mask register can be used to track multiple wait states for each thread.

When conditions causing a thread to be stalled clear, the scheduler 216 updates the thread state accordingly. Thus, the thread scheduler 216 tracks thread state information, including the order in which threads have been executed, whether a thread is ready to be scheduled for execution, whether the thread is currently executing, if it is not ready, then what condition is keeping it from executing and so on.

By way of example, the instruction fetch and scheduling unit (IFU) 201 retrieves instructions and program counter information for each thread, stores the instructions in the instruction cache 202 and in the instruction buffers 204 and stores the associated program counter in a PC logic unit 226. For each thread, the instruction register 204 can include a thread instruction register (TIR) for holding the current stage instruction, and a next instruction register (NIR) for holding the instruction at the next PC.

The status of each thread is monitored and stored by the scheduler 216. Based upon thread status information stored in the thread state register 218 and wait mask register 220 and the ordering information stored in the LRE Queue 222, thread select logic 224 in the scheduler 216 selects a thread to execute from among the different threads, and issues a thread select signal 217 to the thread select multiplexer 206 to retrieve the selected thread's instruction from the instruction buffer 204.

The retrieved instruction is sent to the decoder 208 that decodes the instruction and supplies the pre-decoded instruction to the execution unit 211. In addition, the thread select signal 217 is issued to the thread select multiplexer 228 to control delivery of program counter information to the instruction cache 202 (e.g., by specifying the program counter location for the next instruction in the instruction cache 202 that is to be translated by the ITLB 229).

Each execution unit 211 includes an arithmetic logic unit (ALU) for performing multiplication, shifting and/or division operations. In addition, the execution unit 211 processes and stores thread status information in integer register files 210. Execution unit results are supplied to the LSU 213 which handles memory references between the processor core, the L1 data cache and the L2 cache. The LSU 213 also buffers stores to the cache or memory using a store buffer for each thread.

The current thread status information recorded in the thread state register 218 and wait mask register 220 is used by the thread scheduler 216 to schedule thread execution in a way that ensures fairness. By way of example, the thread scheduler 216 can give priority to the thread that was least recently scheduled. In another example, thread select logic 224 processes the thread status information from the thread state register 218 and wait mask register 220, and also maintains a thread order register or queue (e.g., LRE Queue 222) in which the thread identifier for a given thread is moved to the front of the queue when the given thread is executed, meaning that the least recently executed thread is at the back of the queue.

The thread select logic 224 can implement a scheduling algorithm whereby a thread can only be scheduled if it is in a ready state, a speculative ready state, a run state or a speculative run state. As between threads that qualify for scheduling, the thread select logic 224 can allocate the highest execution priority using the priority rule, Rdy>SpecRdy>Run=SpecRun. Alternatively, the thread select logic 224 can allocate the highest execution priority using the priority rule (e.g., Idle (with a reset or resume interrupt pending) >Rdy>SpecRdy>Run=SpecRun).

The sequencing of priorities can effectively assign a higher priority to the least recently executed thread, with a lower priority “run” state likely having been more recently executed than a higher priority “ready” state. In the event of any priority tie between two threads that are Rdy or SpecRdy, the thread select logic 224 can allocate the higher execution priority to the thread that was least recently executed.

There will be no priority ties between threads that are in the Run or SpecRun states when only one thread is running in the thread select stage at a time. Within Idled threads, priority can be allocated in any desired way, such as using thread identifiers to allocate priority with an ad hoc rule (e.g., T0>T1>T2>T3). While such a thread allocation is not “fair,” it is acceptable given the relative infrequency of idled threads.

Assigning higher priority to the Ready and SpecRdy states allows the processor to make frequent switches between threads, thereby reducing the probability of being hit by a stall. In comparison, if the Run and SpecRun states were given priority, a thread switch would occur only after a stall is detected, thereby needlessly consuming processor cycles before stall detection occurs.

### Thread Prioritizing

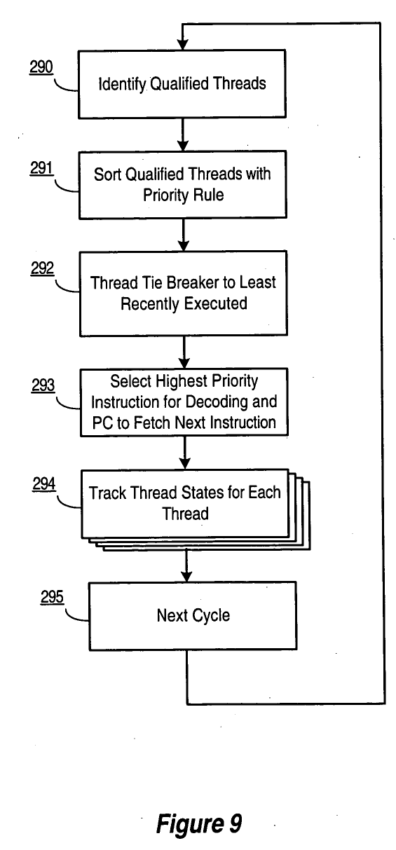

FIG. 9 is a flowchart diagram that illustrates the method operations performed for implementing an efficient and fair thread scheduling system and functionality, in accordance with one embodiment of the present invention. The methodology illustrated in FIG. 9 shows the operations for prioritizing multiple threads for instruction selection and execution, and these operations can occur as a sequence at the beginning or end of each processing cycle. Whether implemented on a single processor core that executes multiple threads or on each core of a multithreaded multiprocessor, the disclosed prioritization operations allow threads that share a common processing resource to be scheduled for execution in a way that ensures correctness, fairness and increased performance.

In addition, the methodology of the present invention may be thought of as performing the identified sequence of operations in the order depicted in FIG. 9, though the operations can also be performed in parallel, in a different order or as independent operations that separately monitor thread status information and sort the threads for execution based on the current thread status information as described herein.

The description of the method can begin at an operation 290, where the threads that are qualified to be ranked or sorted are identified. By way of example, if the scheduling algorithm ranks only active threads, then the thread select logic identifies which threads are in a ready state, a speculative ready state, a run state or a speculative run state. Alternatively, other thread states can qualify under the thread select logic, such as threads that are in an idle state with an interrupt pending.

Once the qualified threads are identified, they are sorted in an operation 291 by the thread select logic 224 using a predetermined priority rule. While any desired prioritization rule can be used, the thread select logic can implement a least recently executed algorithm to allocate the highest execution priority to any thread in the idle state with an interrupt pending, the next highest priority to a thread in the ready state, the next highest priority to a thread in the speculative ready state, and the lowest priority to any thread in the run state or the speculative run state. However, any subset or combination of the foregoing prioritizations can be used, and the prioritization rules can be implemented in any of a variety of ways that are suitable to provide a desired prioritization function.

In an operation 292, allocating the higher priority to the thread that was least recently executed breaks any priority tie between threads. An efficient mechanism for monitoring how recently a thread has been executed is to maintain a thread order queue in which the thread identifier for a given thread is moved to the front of the queue when the given thread is executed. The result is that the least recently executed thread is at the back of the queue. In addition or in the alternative, different prioritization rules can be used for breaking ties between inactive threads (e.g., idled threads), such as by allocating priority using a predetermined ranking of thread identifiers (e.g., T0>T1>T2>T3).

Once the thread with the highest priority is identified, the current instruction and PC for the identified thread is selected for decoding and execution, and the program counter for the next instruction in the identified thread is selected in an operation 293. Thus, instruction scheduling occurs at the same time that the next instruction is fetched so that if the next instruction is available in the NIR, then no fetch operation is needed and the scheduler merely schedules the correct instruction from the NIR.

In an optional operation 294, the thread states for each thread can be monitored to keep track of thread state information (e.g., whether the respective thread is ready to be scheduled for execution, currently executing, what condition is keeping the thread from executing if it is not ready, and/or when such a condition clears, etc.). The thread state can be tracked at the end of each processor cycle. Alternatively, the thread state can be tracked at the beginning of the sequence of operations depicted in FIG. 9. The method operations continue in an operation 295 where a next processing cycle is initiated and the method operations 290-295 repeat.

As set forth above, a method and apparatus for scheduling multiple threads for execution in a microprocessor is described. For clarity, only those aspects of the processor system germane to the invention are described, and product details well known in the art are omitted. For the same reason, the computer hardware is not described in further detail. It should thus be understood that the invention is not limited to any specific logic implementation, computer language, program, or computer.

While various details are set forth in the above description, it will be appreciated that the present invention can be practiced without these specific details. By way of example, selected aspects are shown in block diagram form, rather than in detail, in order to avoid obscuring the present invention. Some portions of the detailed descriptions provided herein are presented in terms of algorithms or operations on data within a computer memory. Such descriptions and representations are used by those skilled in the field of microprocessor design to describe and convey the substance of their work to others skilled in the art.

In general, an algorithm refers to a self-consistent sequence of operations leading to a desired result, where an “operation” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities.

Unless specifically stated otherwise as apparent from the following discussion, it is appreciated that throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

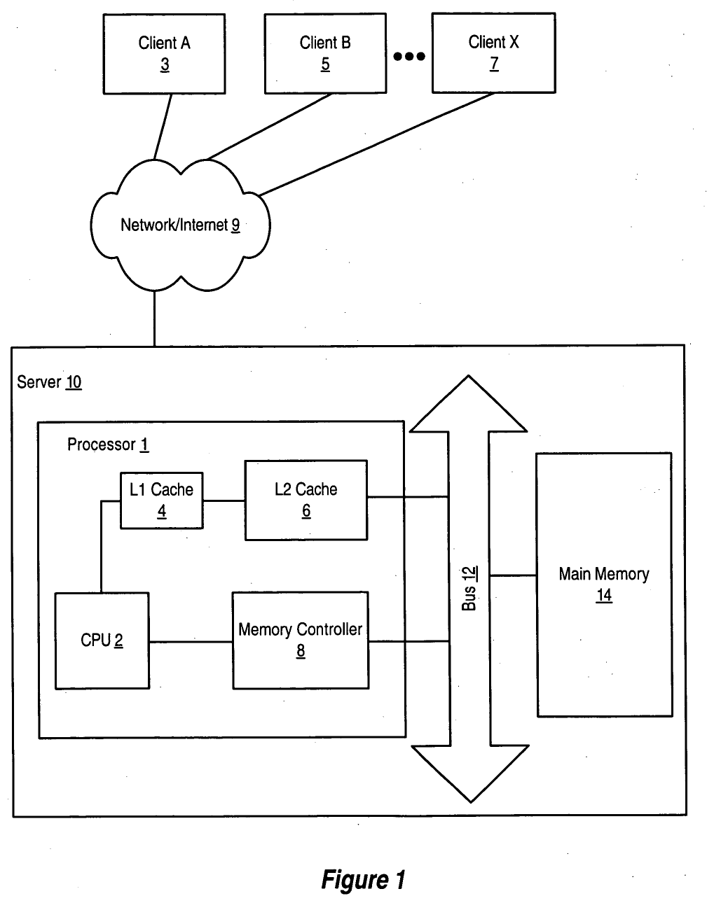

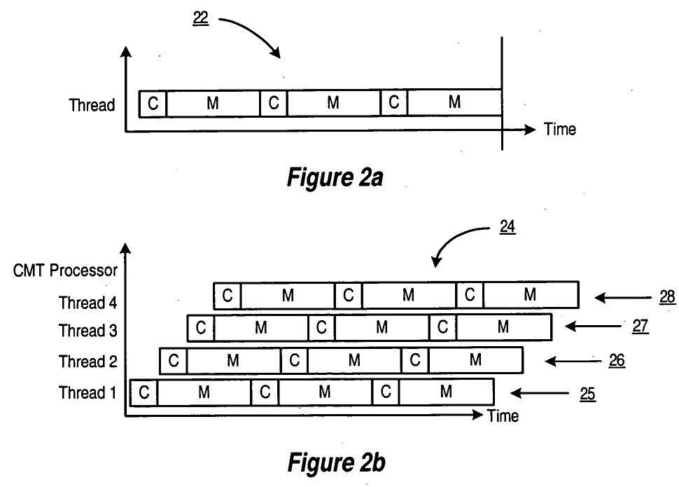

While the present invention has been particularly described with reference to FIGS. 1-9 and with emphasis on certain exemplary processes and structures, it should be understood that the figures are for illustration purposes only and should not be taken as limitations upon the present invention. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A multi-thread processor comprising:
a plurality of threads; and
a scheduler including a thread state register, the thread state register capable of storing a selective wait state for a selected one of the plurality of threads.

2. The multi-thread processor of claim 1 wherein the selective wait state includes at least one of a group consisting of a halt state or an idle state.

3. The multi-thread processor of claim 1, wherein the multi-thread processor includes a plurality of cores and wherein each of the cores include at least one of the plurality of threads.

4. A method of scheduling threads in a multi-thread processor comprising:
receiving a first instruction in a first thread of a plurality of threads in the multi-thread processor, the first instruction is a selective wait state instruction; and
executing the first instruction including:
selecting one of the plurality of threads included in the multi-thread processor; and
setting a thread state to a selective wait state in a thread state register included in the multi-thread processor, wherein the thread state register corresponds with the selected thread.

5. The method of claim 4, wherein the selective wait state includes a halt state.

6. The method of claim 5, wherein the halt state includes holding a plurality of data values in the selected thread until a resume-halt instruction is received.

7. The method of claim 5, wherein the halt state includes not scheduling the selected thread for activity in the scheduler until a resume-halt instruction is received.

8. The method of claim 7, wherein a resume-halt includes receiving a second instruction to change the status of selected thread to an active state.

9. The method of claim 7, wherein a resume-halt includes at least one of an instruction, an interrupt or a reset.

10. The method of claim 7, wherein the second instruction is received in a second thread of a plurality of threads in the multi-thread processor that is not the selected thread.

11. The method of claim 4, wherein the selective wait state includes an idle state.

12. The method of claim 11, wherein the idle state includes holding a plurality of data values in the selected thread until a resume-idle instruction is received.

13. The method of claim 1, wherein the idle state includes not scheduling the selected thread for activity in the scheduler until a resume-idle instruction is received.

14. The method of claim 13, wherein a resume-idle includes receiving a second instruction to change the status of selected thread to an active state.

15. The method of claim 13, wherein a resume-idle includes at least one of an instruction or a reset.

16. The method of claim 4, wherein the first instruction is generated in response to at least one of a temperature of the multi-thread processor, a power consumption level of the multi-thread processor, or an error rate of the selected thread.

17. The method of claim 1, wherein setting the thread state to a selective wait state in a thread state register includes selecting one of a halt state or an idle state.

18. A method of initializing a multi-thread processor comprising:
applying power to the multi-thread processor, the processor including a plurality of threads;
placing a selected at least one of the plurality-of threads in a selective wait state;
initializing a plurality of operations in the multi-thread processor; and
placing the selected at least one of the plurality of threads in an active state.

19. The method of claim 18, wherein placing the selected at least one of the plurality of threads in the selective wait state includes:
receiving a selective wait state instruction in a first thread of the plurality of threads in the multi-thread processor; and
executing the first instruction including:
selecting one of the plurality of threads included in the multi-thread processor; and
setting a thread state to a selective wait state in a thread state register included in the multi-thread processor, wherein the thread state register corresponds with the selected thread.

20. The method of claim 18, wherein the selective wait state includes a halt state.

21. The method of claim 20, placing the selected at least one of the plurality of threads in an active state includes:
receiving a resume-halt instruction; and
executing the resume-halt instruction.
